(19) United States
(12) Patent Application Publication
(10) Pub. No.: US 2015/0146293 A1
(43) Pub. Date: May 28, 2015

(54) METHOD FOR PRODUCING OPTICAL FILM LAMINATE, THIN POLARIZING FILM, POLARIZING PLATE, AND LIQUID CRYSTAL DISPLAY DEVICE

(71) Applicant: Konica Minolta, Inc., Tokyo (JP)

(72) Inventor: Tatsuya Sasaki, Hachioji-shi (JP)

(21) Appl. No.: 14/401,023

(22) PCT Filed: Jun. 14, 2013
(86) PCT No.: PCT/JP2013/066462

§ 371 Date: Nov. 13, 2014

(30) Foreign Application Priority Data
Jun. 21, 2012 (JP) 2012-139290

(51) Int. Cl. G02B 1/18; B32B 38/08; B32B 38/00; B32B 38/10; G02B 5/30; B32B 37/24

(52) U.S. Cl. CPC G02B 1/18; G02B 5/3025; B32B 37/24; B32B 38/0012; B32B 38/10; B32B 38/08; B32B 2037/243; B32B 2038/0028
USPC 359/487.02; 156/229

(57) ABSTRACT

The present invention addresses the problem of providing: a method for producing an optical film laminate that has a thin polarizing film and is free from unevenness in the degree of polarization in the film width direction; a thin polarizing film which is free from unevenness in the degree of polarization; and a liquid crystal display device. A method for producing an optical film laminate according to the present invention comprises: (1) a lamination step wherein a hydrophilic polymer layer is laminated on a thermoplastic resin base, thereby forming a laminate; (2) a stretching step wherein the laminate is stretched in the air, thereby forming a stretched laminate that comprises an oriented hydrophilic polymer layer; and (3) a dyeing step wherein the hydrophilic polymer layer is caused to adsorb a dichroic dye. This method for producing an optical film laminate is characterized in that the temperature of the base in an end portion in the TD direction, on said portion the hydrophilic polymer layer being not laminated, is higher than the temperature of the base in the central portion in the TD direction by 1-40° C. during the stretching in the air.

### TECHNICAL FIELD

The present invention relates to a method for producing an optical film laminate, a thin polarizing film, a polarizing plate and a liquid crystal display device, in particular to a thin polarizing film that is used for advanced thin and light-weight liquid crystal display devices.

### BACKGROUND ART

In recent years, liquid crystal display devices have come to be used for mobile tablets and smartphones, and they have been getting thinner and lighter.

A liquid display device is made of a variety of components. Among them, a polarizing film has been manufactured by a method for manufacturing a single layer. In Patent Document 1, for example, a polarizing film is manufactured by processing a 50 to 80 μm-thick PVA resin single layer with a conveying machine that includes a plural sets of rollers with different peripheral speeds, immersing the PVA resin single layer in a staining solution to allow a dichroic substance to adsorb on it, and stretching it in an aqueous solution at around 60° C. This single layer polarizing film has a thickness within the range from 15 to 35 μm.

Since the above-described method is limited in terms of thinning a polarizing film, novel thinning techniques have been proposed (see Patent Document 2). Patent Document 2 discloses a method for manufacturing an optical film laminate including a thin polarizing film including: stretching in the air a film laminate that includes a polyvinyl alcohol resin layer formed on an amorphous ester thermoplastic resin base in the machine direction (film conveying direction), and allowing a dichroic substance to adsorb on the oriented polyvinyl alcohol.

However, in the polarizing film produced by this method, slight non-uniformity of stretching readily results in non-uniform orientation due to the thin film thickness. Furthermore, as a result of an inventors study, they found that the optical film laminate produced by this method has a difference in polarization degree between the edge parts and the center part in the transverse direction (transverse direction of the film), in particular has non-uniform polarization degree in the edge parts, which is a peculiar problem with the polarizing film produced by this method.

Further, liquid crystal display devices using this polarizing film have a decreased contrast in the part where the polarization degree of the polarizing film is low, and thus have non-uniform contrast. However, these problems have not been recognized.

### PRIOR ART DOCUMENT

### Patent Document

Patent Document 1: JP 2005-266325A
Patent Document 2: JP 4691205B

### SUMMARY OF INVENTION

### Problem to be Solved by the Invention

The present invention was made in consideration of the above-described problems and circumstances, and an object thereof is to provide a method for producing an optical film laminate that includes a thin polarizing film having uniform polarization degree in the transverse direction of the film. Further objects are to provide a thin polarizing film and a thin polarizing plate having uniform polarization degree, and to provide a thin liquid crystal display device having uniform contrast.

### Means for Solving the Problem

In the course of a study to figure out the cause of the above-described problems and to solve them, the present inventors found that the polarization degree of an optical film laminate differs between the center part in the transverse direction of a hydrophilic polymer layer and the edge parts in the transverse direction of the hydrophilic polymer layer. To cope with this problem, they found that the difference in polarization degree between the center part and the edge parts of the hydrophilic polymer layer can be reduced by controlling the temperature during stretching of the optical film laminate in the air such that the temperature at the edges of a base where the hydrophilic polymer layer is not laminated becomes higher than the temperature at the center part of the base where the hydrophilic polymer layer is laminated.

That is, the above-described objects of the present invention are achieved by the following means.

1. A method for producing an optical film laminate, comprising:

(1) a laminating step of laminating a hydrophilic polymer layer on a thermoplastic resin base to form a laminate;

(2) a stretching step of stretching the laminate in the air to form a stretched laminate comprising the oriented hydrophilic polymer layer; and

(3) a staining step of allowing a dichroic substance to adsorb on the hydrophilic polymer layer,

wherein, in the stretching step in the air, a temperature of an edge part of the base in a transverse direction where the hydrophilic polymer layer is not laminated is 1° C. to 40° C. higher than a temperature of a center part of the base in the transverse direction.

2. The method for producing the optical film laminate according to claim 1,

wherein the hydrophilic polymer layer of the optical film laminate has a thickness within a range from 2 to 10 μm,

wherein the base of the optical film laminate has a thickness within a range from 5 to 45 μm, and

wherein the base before the laminating step has a water absorption coefficient determined by the following Expression (1) according to JIS K 7209 (Method A) within a range from 0.3% to 4.3%,

Water absorption coefficient=(w₂−w₁)/w₁×100(%), Expression (1):

where w₁ is a dry mass (mg) of a test piece before being immersed in water, and w₂ is a mass (mg) of the test piece after being immersed in water at 23.0±1.0° C. for 24±1 hours.

3. The method for producing the optical film laminate according to claim 1 or 2, wherein a hydrophilic polymer of the hydrophilic polymer layer is a polyvinyl alcohol resin.

4. The method for producing the optical film laminate according to any one of claims 1 to 3, wherein the hydrophilic polymer layer is a thin polarizing film that is adjusted such that a polarization degree A at a center in the transverse direction of the thin polarizing film and a polarization degree B at 25 mm inward from an edge in the transverse direction of the thin polarization film satisfy the following Expression (2).

0.999≦A/B≦1.001 Expression (2):

5. The method for producing the optical film laminate according to any one of claims 1 to 4, further comprising, in addition to the steps (1) to (3), the steps of:

(4) a pasting step of pasting a second optical film on a surface of the hydrophilic polymer layer via an adhesive; and

(5) a peeling step of peeling off the base.

6. A thin polarizing film that is a hydrophilic polymer layer having a thickness of 2 to 10 μm, wherein a polarization degree A at a center of the polarizing film in the transverse direction and a polarization degree B at 25 mm inward from an edge of the polarization film in the transverse direction satisfy the following Expression (2),

0.999≦A/B≦1.001. Expression (2):

7. A polarizing plate comprising an optical film laminate that is produced by the method for producing the optical film laminate according to any one of claims 1 to 5.

8. A liquid display device comprising an optical film laminate that is produced by the method for producing the optical film laminate according to any one of claims 1 to 5.

### Advantageous Effects of Invention

With the above-described means of the present invention, it becomes possible to provide the method for manufacturing an optical film laminate having uniform polarization degree. Further, it also becomes possible to provide the thin polarizing film that has uniform polarization degree in the transverse direction although the thickness of the hydrophilic polymer polarizing film is as thin as 2 to 10 μm.

The mechanism of how the advantageous effects of the present invention develop and function has not revealed yet, but it is presumed as follows.

When a hydrophilic polymer aqueous solution is applied on a base while the base is being conveyed by a roller, the solution is not applied on the edge parts of the base in the transverse direction in order to prevent the applied hydrophilic polymer from flowing from the front face to the backside to smear the conveying roller. After being dried, the hydrophilic polymer layer is stretched in the transverse or machine direction. However, the hydrophilic polymer layer is not completely dried at this point. If the base can absorb water to some extent, the part of the base where the hydrophilic polymer layer is laminated contains water even during the stretching step since it absorbs water from the hydrophilic polymer layer.

As a result, the part of the base where the hydrophilic polymer layer is laminated exhibits an elastic modulus lower than the edge parts of the base where the hydrophilic polymer layer is not laminated. When the film is stretched in the transverse or machine direction in this condition, it is presumed that the center part and the edge parts are stretched differently from each other, which results in a difference in orientation of the hydrophilic polymer layer in the transverse direction of the film. It is assumed that this difference in orientation of the hydrophilic polymer layer takes the form of a difference in polarization degree of the optical film laminate that is manufactured by allowing a dichroic substance to adsorb on the layer, which results in non-uniform polarization degree.

### BRIEF DESCRIPTION OF DRAWINGS

FIG. 1 is a schematic view of the steps of a manufacturing method of the present invention.

FIG. 2 is a schematic view of a stretching step viewed from the normal direction of a laminate.

### DESCRIPTION OF EMBODIMENTS

A method for producing an optical film laminate of the present invention includes: (1) a laminating step of laminating a hydrophilic polymer layer on a thermoplastic resin base to form a laminate; (2) a stretching step of stretching the laminate in the air to form a stretched laminate including the oriented hydrophilic polymer layer; and (3) a staining step of allowing a dichroic substance to absorb in the hydrophilic polymer layer, wherein during the stretching step in the air, the temperature of the edge parts of the base in the transverse direction where the hydrophilic polymer layer is not laminated is 1° C. to 40° C. higher than the temperature of the center part of the base in the transverse direction.

This temperature difference can compensate the difference in elastic modulus caused by the difference in moisture content of the base between the center part on which the hydrophilic polymer layer is laminated and the edge parts. As the advantageous effect of the present invention is thus exerted, it has become possible for the first time to obtain a thin polarizing film having a non-uniformity of the polarization degree in the transverse direction of

0.999≦A/B≦1.001, Expression (2):

although it is a hydrophilic polymer polarizing film as thin as 2 to 10 μm.

In an embodiment of the present invention, it is preferred that, after the midair stretching, the thickness of the hydrophilic polymer layer is within the range from 2 to 10 μm, the thickness of the base is within the range from 5 to 45 μm, and the moisture content of the base is within the range from 0.3% to 4.3% in terms of exerting the advantageous effects of the present invention. Further, it is preferred that the hydrophilic polymer of the hydrophilic polymer layer is polyvinyl alcohol in order to achieve high polarization degree.

Further, in the present invention, the hydrophilic polymer is preferably a polyvinyl alcohol resin, and is preferably stained with iodine. This allows obtaining a polarizing film with high polarization degree.

In addition to the above steps (1) to (3), the method may further includes: (4) a pasting step of pasting a second optical film on the surface of the hydrophilic polymer layer via an adhesive, and (5) a peeling step of peeling off the base. These steps make it possible to design the optical film without considering an influence exerted by stretching the hydrophilic polymer layer, which allows combination use with an optimal optical film.

By using the method of producing the optical film laminate of the present invention, it has become possible for the first time to obtain the thin polarizing film in which the polarization degree A at the center part in the transverse direction and the polarization degree B at 25 mm inward from an edge in the transverse direction satisfy the relation: 0.999≦A/B≦1.001 while the thickness of the hydrophilic polymer layer polarizing film is as thin as 2 to 10 μm.

The optical film laminate of the present invention may be suitably used in polarizing plates and liquid crystal display devices.

Hereinafter, the present invention and the components thereof and embodiments of the present invention will be described in detail. As used herein, the symbol “-” is used to mean that the values before and after it are included in the range as the lower limit and the upper limit.

Method for Producing Optical Film Laminate

The method of producing the optical film laminate of the present invention includes: (1) a laminating step of laminating a hydrophilic polymer layer on a thermoplastic resin base to form a laminate; (2) a stretching step of stretching the laminate in the air to form a stretched laminate including the oriented hydrophilic polymer layer; and (3) a staining step of allowing a dichroic substance to adsorb on the hydrophilic polymer layer, wherein during the stretching step in the air, the temperature of the edge parts of the base in the transverse direction where the hydrophilic polymer layer is not laminated is 1° C. to 40° C. higher than the temperature of the center part of the base in the transverse direction. To control the temperature of the edge parts of the base in the transverse direction where the hydrophilic polymer layer is not laminated to be 1° C. to 40° C. higher than the temperature of the center part of the base in the transverse direction, a heater at the edge parts may be operated to be hotter than a heater at the center part. Alternatively, the whole surface of the film may be heated once, and only the center part may then be cooled. If the temperature differs between the left edge and the right edge, the edge temperature refers to their average.

### SUMMARY OF PRODUCTION STEPS

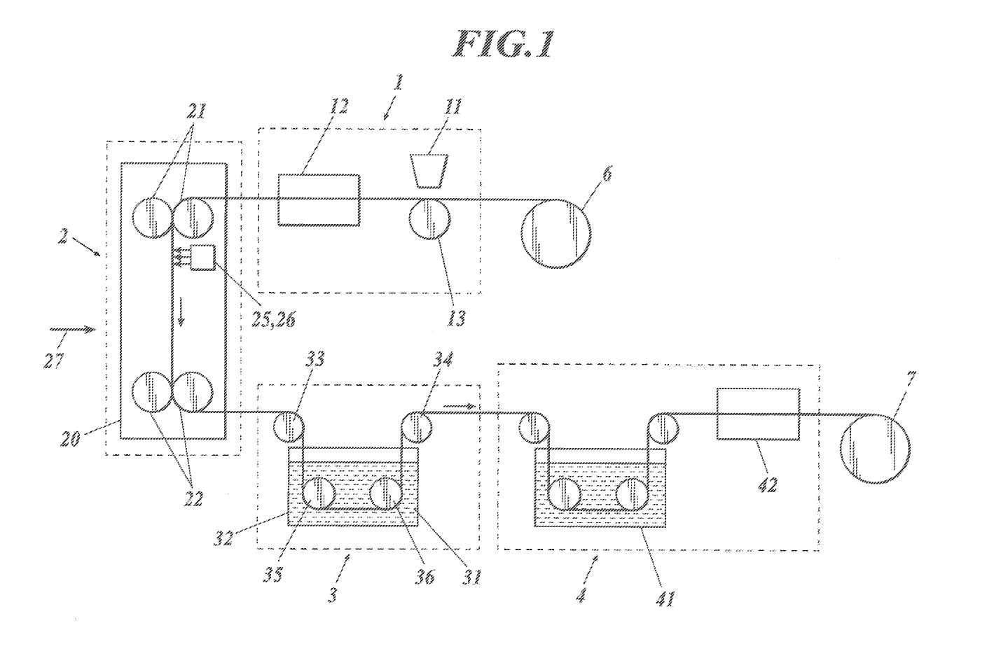

FIG. 1 illustrates an example of the process for producing the optical film laminate of the present invention. The process in FIG. 1 include a laminating step 1, a stretching step 2, a staining step 3 and a washing and drying step 4. Although not shown in FIG. 1, the process may further involve a step of stretching in a cross-linking agent solution between the staining step 3 and the washing and drying step 4.

As used herein, the “machine direction” refers to the conveying direction of the film laminate in the laminating step 1, stretching step 2, staining step 3 and washing and drying step 4 in FIG. 1, and the “transverse direction” refers to the direction perpendicular to the machine direction in the plane of the film laminate, i.e. the width direction of the film laminate.

(1) Laminating Step

In the laminating step 1, a hydrophilic polymer solution is applied by a coater 11 to the base reeled out from the roll 6, and is dried by a dryer 12 to form the laminate. In order that a back roller 13 is not smeared with the hydrophilic polymer solution supplied from the coater 11, the coater 11 is designed such that the application width of the hydrophilic polymer becomes narrower than the width of the base.

While the base reeled out from the roll 6 is being conveyed toward the coater 11, it may undergo a surface treatment step (not shown) for adjusting the contact property and the peeling property.

Although not shown in the figure, instead of using the roll of the base, the laminating step may involve laminating the base layer and the hydrophilic polymer layer by co-extrusion of the material of the base and the material of the hydrophilic polymer.

The thickness of the hydrophilic polymer layer of the laminate before stretching may be suitably selected according to a desired thickness of the hydrophilic polymer layer (stretched) of the stretched laminate that is obtained after the stretching step. Since it is important to manufacture a thinner polarizing film, the thickness of the hydrophilic polymer layer (stretched) of the stretched laminate is preferably within the range of 0.5 to 30 μm, more preferably within the range of 1 to 20 μm, yet more preferably 2 to 10 μm. If the thickness of the hydrophilic polymer layer (stretched) is equal to or greater than 2 μm, the manufactured layer has a uniform thickness, and a very favorable appearance can be achieved. If the thickness of the hydrophilic polymer layer is equal to or less than 10 μm, the layer can sufficiently meet the demand for thinner liquid display devices.

The hydrophilic polymer layer of the laminate is stretched or shrunk by a stretching treatment to have the above-described thickness. Accordingly, it is preferred that the thickness of the hydrophilic polymer layer of the unstretched laminate is typically within the range approximately from 1 to 50 μm, preferably within the range from 2 to 30 μm. Further, for performing stretching, etc. on the laminate, it is preferred that the moisture content of the hydrophilic polymer layer of the laminate is within the range from 1 to 40 mass %, more preferably within the range from 2 to 25 mass %.

After the aqueous solution containing the hydrophilic polymer is applied on the base, the solution containing the hydrophilic polymer is dried so that the hydrophilic polymer layer is formed on the base. The laminate is thus obtained. This application process gives the laminate of the base and the hydrophilic polymer layer integrated with each other, in which the base and the hydrophilic polymer layer are laminated with each other via a primer layer or a peeling layer, or the base and the hydrophilic polymer layer are directly laminated with each other. The aqueous solution may be prepared by suitably dissolving a powder of the hydrophilic polymer or a ground or shredded film or the like of the hydrophilic polymer in water (hot water) that is heated according to circumstances.

The aqueous solution may be applied on the base by any application method that is suitably selected from roll coating methods such as wire bar coating, reverse coating and gravure coating, a spin coating method, a screen coating method, a fountain coating method, a dipping method, spraying and the like. If the base includes the primer layer or the peeling layer, the aqueous solution is applied on the primer layer or the peeling layer. If the primer layer is absent, the aqueous solution is directly applied on the base. The drying temperature is typically within the range from 50° C. to 200° C., preferably within the range from 80° C. to 150° C. The drying time is typically within the range approximately from 5 to 30 minutes.

It is preferred that the aqueous solution is applied on the each edge of the base with a width of 0.5 to 35 mm in the transverse direction so that the hydrophilic polymer layer is formed. It is more preferred that the solution is applied with a width of 5 to 35 mm. The width equal to or greater than 5 mm can prevent the convey roller from being smeared with the aqueous solution even if the conveyed base swings to some extent. The width equal to or less than 35 mm allows high yield of the optical film laminate.

(2) Stretching Step

For the stretching step 2 as illustrated in FIG. 1, a stretching machine is installed which has a roller pair 21 and a roller pair 22 in an oven 20. The laminate is firstly conveyed from the laminating step 1, and is then stretched in the air such that the roller pair 21 and the roller pair 22 nip the laminate respectively at the upstream and at the downstream to pass it through the air between the roller pairs while the oven heat it at a high temperature. The oven 20 heats the laminate at a temperature enough to make the laminate stretchable. In this condition, by controlling the circumferential speed of the rollers of the roller pair 22 to be faster than the circumferential speed of the rollers of the roller pair 21, the laminate between the roller pairs 21 and 22 is stretched uniaxially in the longitudinal direction (stretched in the machine direction) in the mode of free end stretching.

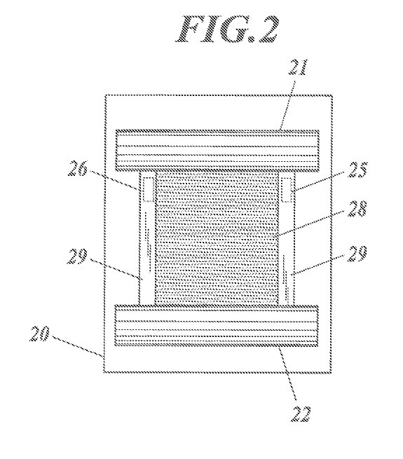

FIG. 2 illustrates the stretching step 2 viewed from the direction 27 of FIG. 1. The laminate in the air between the roller pair 21 and the roller pair 22 is composed of a laminated portion 28 where the hydrophilic polymer layer is laminated and edge portions 29 where the hydrophilic polymer layer is not laminated. Hot air is blown to the base in the edge portions 29 by heaters 25 and 26 from the side where the hydrophilic polymer layer is not laminated, so that the temperature of the edge portions 29 is higher than the temperature of the laminated portion 28 of the base.

Free end stretching and fixed end stretching are briefly described here. When a long film is stretched in the conveying direction, the film shrinks in the direction perpendicular to the stretching direction, i.e. the width direction. Free end stretching refers to such a stretching method without preventing the shrinkage. Further, uniaxial stretching in the longitudinal direction refers to a stretching method of stretching only in the longitudinal direction. Free end stretching can be compared with fixed end stretching that is performed while preventing the shrinkage in the perpendicular direction. By such free-end uniaxial stretching, the hydrophilic polymer in the laminate is oriented, and the laminate is processed to be a stretched laminate.

The method of producing the optical film laminate of the present invention includes the step of stretching the laminate in the air to form the stretched laminate that includes the oriented hydrophilic polymer layer. During the midair stretching, the temperature of the edge parts of the base in the transverse direction (the parts where the hydrophilic polymer layer is not laminated) is 1° C. to 40° C. higher than the temperature of the center part of the base in the transverse direction. The temperature of the base is measured by a radiation thermometer.

If the temperature differs by less than 1° C. or greater than 40° C. between the edge parts and the center part of the base, it causes significant non-uniformity of the polarization degree.

If the temperature differs by less than 1° C. between the edge parts and the center part of the base, it is assumed that the elastic modulus of the unmoist edge parts of the base is not decreased to the value of the elastic modulus of the moist center part of the base. If the temperature differs by over 40° C. between the edge parts and the center part of the base, it is assumed that the edge parts of the hydrophilic polymer layer are locally dried to cause non-uniformity of the orientation, which results in non-uniform polarization degree.

In a film production by stretching, it was unthinkable to heat edge parts because it generally causes local stretch only in the edge parts, neck-in or the like, which results in non-uniform thickness or the like. However, in the present invention, heating the edge parts at a high temperature can rather produce an effect of reducing non-uniformity of the polarization degree in the width direction.

In the stretching step, the aqueous solution of the hydrophilic polymer is applied on the base, and the midair stretching is carried out before it is completely dried. At the start of the midair stretching, since the hydrophilic polymer layer is not completely dried, the moisture is also diffused in the base. Accordingly, the moisture content at the center part of the laminate of the base is higher than the moisture content at the edge parts in the transverse direction of the base. As used herein, midair stretching refers to, for example, “stretching in the air at a high temperature” by using a heater such as an oven, but is not limited thereto. Further, a laminate obtained by the midair stretching is referred to as a stretched laminate.

It is preferred that the midair stretching is performed at a stretch ratio in the machine direction of 3.5 or less at a stretching temperature within the range from the glass transition temperature to the crystallization temperature of the base. This is because a temperature less than the glass transition temperature or over the crystallization temperature makes it difficult to perform the stretching. If polyethylene terephthalate or amorphous polyester is used for the base, it is more preferred that the temperature of the base at the center part in the transverse direction is within the range from 70° C. to 150° C. in the midair stretching.

The stretch in the machine direction occurs between the point where the laminate web is released from the upstream convey rollers and the point where the web comes in contact with the downstream convey rollers when the downstream convey rollers rotates at a higher circumferential speed than the upstream convey rollers so as to convey the web of the laminate.

Examples of means for controlling the temperature of the center part in the transverse direction include adjusting the temperature of the oven installed in the stretching machine, and the like. Examples of means for controlling the temperature of the edge parts of the base in the transverse direction to be higher than the temperature of the center part include infrared irradiation, an electric heater, microwave irradiation, hot air, contact with a heating roller, and the like. If hot air is blown, it is preferred that hot air is blown to the side opposite the applied side (i.e. the base side) in order to prevent that the hydrophilic polymer layer is unevenly dried.

As used herein, a stretch ratio refers to a ratio of film length W/W0 in the stretching direction before and after stretching (W is the length after the stretching, and W0 is the length before the stretching).

(3) Staining Step

Next, in the staining step 3 illustrated in FIG. 1, a dichroic substance adsorbs on the hydrophilic polymer layer where the hydrophilic polymer is oriented, so that the stained laminate is formed. In a staining machine including a staining bath 32 filled with a staining solution 31 as illustrated in FIG. 1, while the stretched laminate is being conveyed by rollers 33 to 36, it is immersed in the staining solution 31. The stained laminate in which the dichroic substance adsorbs in an oriented state is thus obtained.

The stained laminate that has passed through the staining step 3 undergoes the washing and drying step 4 that is provided with a washing machine 41 for removing the non-oriented dichroic substance and a drying machine 42. The optical film laminate thus formed is then wound on a roll 7.

The staining step involves allowing the dichroic substance to adsorb on the hydrophilic polymer layer of the stretched laminate in an oriented state. The staining step may be performed before, after or at the same time with the stretching step. However, in order to allow the adsorbed dichroic substance on the hydrophilic polymer layer to be well oriented, it is preferred that the staining step is performed after the laminate undergoes the stretching step.

The method for producing the optical film laminate of the present invention may further include a cross-linking step in addition to the stretching step and the staining step. The cross-linking step involves a cross-linking treatment that may be carried out, for example, by immersing the stretched laminate or the stained stretched laminate in a solution containing a cross-linking agent (cross-linking solution). By stretching the laminate in the cross-linking solution, the dichroic substance can be further oriented.

(4) Pasting Step/(5) Peeling Step

Besides the above-described steps (1) to (3), adding (4) the pasting step of pasting the second optical film on the surface of the hydrophilic polymer layer via an adhesive and (5) the peeling step of peeling off the base makes it possible to obtain various types of optical film laminates in which the hydrophilic polymer layer is laminated on a different optical film from the base that is stretched in the air together with the hydrophilic polymer layer.

With regard to the optical film laminate including the hydrophilic polymer layer formed on the base, (4) the pasting step and (5) the peeling step can be carried out at the same time by applying the adhesive as described in the following Pattern 1 in the (4) pasting step/(5) peeling step. Alternatively, the (4) pasting step/(5) peeling step can be carried out by using an adhesive sheet and transferring the adhesive onto the hydrophilic polymer layer as described in Pattern 2.

Since the produced hydrophilic polymer layer typically has a thickness of only 10 μm or less due to thinning by the stretching, it is difficult to handle the hydrophilic polymer layer in the form of a single layer. For this reason, the hydrophilic polymer layer is formed on the base and is used as the optical film laminate, or it is peeled off and pasted onto the second optical film via the adhesive so that it can be used as a different optically functional film laminate. The two patterns for the steps (4) and (5) are described below.

Pattern 1

The (4) pasting step/(5) peeling step involves applying the adhesive either on the hydrophilic polymer layer of the continuous web of the optical film laminate or on the second optically functional film, and winding them while pasting the film, wherein in the winding step, the base is peeled off while the hydrophilic polymer layer is being transferred to the second optical film. A different type of optically functional film laminate in which the hydrophilic polymer layer and the second optical film are laminated is thus formed.

Pattern 2

(4) The pasting step involves pasting an adhesive sheet composed of a separator and an adhesive layer laminated on the separator on the hydrophilic polymer layer of the optical film laminate so as to laminate the separator via the adhesive layer, and subsequently peeling off the separator and pasting the second optical film on the exposed adhesive. (5) The peeling step involves peeling off the base. A different type of optically functional film laminate in which the hydrophilic polymer layer and the second optical film are laminated is thus formed.

Optical films that are used as the second optical film include, for example, a viewing angle expanding film for liquid crystal display devices, a reverse-dispersion film for liquid crystal display devices for preventing hue change depending on a change of a view angle, a λ/4 phase difference film for organic EL display devices for preventing reflection of external light to improve the contrast.

Hydrophilic Polymer Layer

The hydrophilic polymer layer of the optical film laminate of the present invention is a layer that is formed by uniaxially stretching a layer containing the hydrophilic polymer formed on the base to allow the hydrophilic polymer to be oriented and allowing the dichroic substance to adsorb on the layer. The hydrophilic polymer layer is preferably a thin polarizing film.

Polyvinyl Alcohol Resins

Preferred hydrophilic polymers that can be used to form the hydrophilic polymer layer include polyvinyl alcohol resins. Such polyvinyl alcohol resins include, for example, polyvinyl alcohol and the derivatives thereof. Such derivatives of polyvinyl alcohol include polyvinyl formal, polyvinyl acetal and the like, and also include compounds modified by olefins such as ethylene and propylene, unsaturated carboxylic acids such as acrylic acid, methacrylic acid and crotonic acid, alkyl esters of such unsaturated carboxylic acids, such unsaturated carboxylic acids modified by acrylamide and the like. The degree of polymerization of polyvinyl alcohol are preferably within the range approximately from 100 to 10000, more preferably within the range from 300 to 3000.

The degree of saponification is typically within the range approximately from 80 to 100 mol %. In addition, other hydrophilic polymers that can be used include partially saponified ethylene-vinyl acetate copolymers, dehydration products of polyvinyl alcohol, dehydrochlorination products of polyvinyl chloride, and the like. Among the polyvinyl alcohol resins, polyvinyl alcohol is preferably used as the hydrophilic polymer.

The polyvinyl alcohol resins may contain an additive such as plasticizer and surfactant. Such plasticizers include polyols and the condensation products thereof, for example, glycerin, diglycerin, triglycerin, ethylene glycol, propylene glycol, polyethylene glycol and the like. The amount of a plasticizer or the like used is preferably equal to or less than 20 mass % in the polyvinyl alcohol resins, but is not limited thereto.

Base

The material of the base is, for example, a thermoplastic resin that has high transparency, high mechanical strength, good heat stability, good isotropy, good stretchability and the like. Specific examples of such thermoplastic resins include cellulose ester resins such as triacetyl cellulose, polyester resins, polyether sulfone resins, polysulfone resins, polycarbonate resins, polyamide resins, polyimide resins, polyolefin resins, (meth)acrylic resins, cyclic polyolefin resins (norbornene resins), polyallylate resins, polystyrene resins, polyvinyl alcohol resins, and the mixtures thereof.

Preferred materials of the base are polyesters, acrylic resins and cellulose esters, since a water-absorbent base exhibits better contact with the hydrophilic polymer layer at the interface. Amorphous polyesters are particularly preferred since it can be readily stretched.

Such amorphous polyesters may include amorphous polyethylene terephthalates including a polyethylene terephthalate copolymer copolymerized with isophthalic acid, a polyethylene terephthalate copolymer copolymerized with cyclohexane dimethanol and other polyethylene terephthalate copolymers. Further, such amorphous polyesters are preferably a transparent resin so that they can be used in the polarizing plate as an optical functional film for protecting one side of the hydrophilic polymer layer.

Cellulose esters are esters of cellulose and fatty acids. Specific examples of cellulose ester resins include cellulose triacetate, cellulose diacetate, cellulose tripropionate, cellulose dipropionate and the like. Among them, cellulose triacetate is particularly preferred. Cellulose triacetate is available as many commercial products, and is therefore advantageous also in availability and cost. Examples of commercial products of cellulose triacetate include Konica Minolta TAC KC8UX, KC4UX, KC5UX, KC8UY, KC4UY, KC12UR, KC8UCR-3, KC8UCR-4, KC8UCR-5, KC8UE, KC4UE, KC4FR-3, KC4FR-4, KC4HR-1, KC8UY-HA and KC8UX-RHA (Konica Minolta, Inc.), and the like.

The glass transition temperature of such cellulose ester films is preferably within the range from 150° C. to 170° C., and the crystallization temperature is preferably within the range from 180° C. to 200° C.

The polyolefin resins include polyethylene, polypropylene and the like. The cyclic polyolefin resins are, as specific examples, preferably norbornene resins. Cyclic olefin resins are a general term for resins in which cyclic olefin units are polymerized, and for example, include resins described in JP Hei1-240517A, JP Hei3-14882A, JP Hei3-122137A and the like. Specific examples thereof include ring-opening (co)polymerization products of cyclic olefins, addition polymerization products of cyclic olefins, copolymers (typically random copolymers) of a cyclic olefin and an α-olefin such as ethylene and propylene, and the graft polymers thereof modified by unsaturated carboxylic acids and the derivatives thereof, and the hydrogenated products thereof, and the like. Specific examples of such cyclic olefins include norbornene monomers.

Such cyclic polyolefin resins are available as various commercial products. Specific examples thereof include “ZEONEX”, “ZEONOR” (product names, ZEON Corporation), “ARTON” (product name, JSR Corporation), “TOPAS” (product name, TICONA Corp.) and “APEL” (product name, Mitsui Chemicals, Inc.).

The (meth)acrylic resins have a Tg (glass transition temperature) of preferably 115° C. or more, more preferably 120° C. or more, yet more preferably 125° C. or more, particularly 130° C. or more. The resins having a Tg of 115° C. or more have good durability as the polarizing plate. The upper limit of the Tg of the (meth)acrylic resins is not particularly limited. However, the Tg is preferably equal to or less than 170° C. in terms of moldability and the like.

The (meth)acrylic resins include, for example, (meth)acrylates such as polymethyl methacrylate, methyl methacrylate-(meth)acrylic acid copolymers, methyl methacrylate-(meth)acrylate copolymers, methyl methacrylate-acrylate-(meth)acrylic acid copolymers, methyl (meth)acrylate-styrene copolymers (e.g. MS resin), polymers having an aliphatic hydrocarbon group (e.g. methyl methacrylate-cyclohexyl methacrylate copolymer and methyl methacrylate-norbornyl(meth)acrylate copolymer) and the like. Preferred (meth)acrylic resins are poly C1-6 alkyl(meth)acrylates such as polymethyl methacylate. More preferred (meth)acrylic resins are methyl methacrylate resins that are mainly composed of methyl methacrylate (50 to 100 mass %, preferably 70 to 100 mass %).

Specific examples of such (meth)acrylic resins include, for example, ACRYPET VH and ACRYPET VRL20A (Mitsubishi Rayon Co., Ltd.), (meth)acrylic resins having a cyclic structure in the molecule described in JP 2004-70296A, and high-Tg (meth)acrylic resins formed by intermolecular bridging or intermolecular cyclization.

The (meth)acrylic resins may also include (meth)acrylic resins having a lactone ring structure. Such (meth)acrylic resins having a lactone ring structure include those described in JP 2000-230016A, JP 2001-151814A, JP 2002-120326A, JP 2002-254544A, JP 2005-146084A and the like.

Further, the (meth)acrylic resins may also include acrylic resins having an structural unit of unsaturated carboxylic acid alkyl ester or glutaric anhydride. Such acrylic resins include those described in JP 2004-70290A, JP 2004-70296A, JP 2004-163924A, JP 2004-292812A, JP 2005-314534A, JP 2006-131898A, JP 2006-206881A, JP 2006-265532A, JP 2006-283013A, JP 2006-299005A, JP 2006-335902A and the like.

Further, the (meth)acrylic resins may also include thermoplastic resins having a glutarimide unit, a (meth)acrylate unit and an aromatic vinyl unit. Such thermoplastic resins include those described in JP 2006-309033A, JP 2006-317560A, JP 2006-328329A, JP 2006-328334A, JP 2006-337491A, JP 2006-337492A, JP 2006-337493A, JP 2006-337569A and the like.

It is preferred that the base contains at least one additive selected from sugar ester compounds, plasticizers, ultraviolet absorbing agents, antioxidants, fine particles and retardation controlling agents that are described below. The base containing at least one of such additives can be used as a surface protection film or a phase difference film.

The content of the thermoplastic resins in the base is preferably within the range from 50 to 100 mass %, more preferably within the range from 50 to 99 mass %, yet more preferably within the range from 60 to 98 mass %, particularly within the range from 70 to 97 mass %.

Sugar Ester Compounds

If a cellulose ester is used as the material of the base, it is preferred that the base contains a sugar ester compound other than the cellulose ester. A sugar ester compound is a compound that is formed by esterification of a hydroxyl group in a sugar and a monocarboxylic acid.

The sugar component of the sugar ester compound is preferably a compound in which 1 to 12 pieces of at least either furanose structure or pyranose structure is/are bound to each other.

Examples of such sugar components of the sugar ester compound include monosaccharides such as glucose, galactose, mannose, fructose, xylose and arabinose; disaccharides such as lactose, sucrose, maltitol, lactitol, lactulose, cellobiose, maltose and gentiobiose; trisaccharides such as cellotriose, maltotriose, raffinose, kestose, gentitriose and xylotriose; and tetra- or more saccharides excluding cellulose such as nystose, 1F-furactosyl nystose, stachyose, gentiotetraose and galactosyl sucrose. Examples of such sugar components of the sugar ester also include oligosaccharides such as malto-oligosaccharide, isomalto-oligosaccharide, fructo-oligosaccharide, galacto-oligosaccharide and xylo-oligosaccharide. These oligosaccharides are produced by treating starch or sucrose with an enzyme such as amylase.

Among them, preferred sugars are those including both pyranose structure and furanose structure. More preferred sugars are sucrose, kestose, nystose, 1F-furactosyl nystose and stachyose. A yet more preferred sugar is sucrose.

The monocarboxylic acid of the sugar ester compound is not particularly limited, and may be an aliphatic monocarboxylic acid, an alicyclic monocarboxylic acid or an aromatic monocarboxylic acid known in the art. In order that the film readily exhibits retardation, an aromatic monocarboxylic acid is preferred. The monocarboxylic acid may be a pure compound or a mixture of two or more compounds. For example, an aliphatic monocarboxylic acid and an aromatic monocarboxylic acid may be used in combination.

Examples of such aliphatic monocarboxylic acids include saturated fatty acids such as acetic acid, propionic acid, lactic acid, isobutyric acid, valeric acid, caproic acid, enanthic acid, caprylic acid, pelargonic acid, capric acid, 2-ethyl-hexane carboxylic acid, undecylic acid, lauric acid, tridecylic acid, myristic acid, pentadecylic acid, palmitic acid, heptadecylic acid, stearic acid, nonadecanoic acid, arachic acid, behenic acid, lignoceric acid, cerotic acid, heptacosanic acid, montanic acid, melissic acid and lacceric acid; unsaturated fatty acids such as undecylenic acid, oleic acid, sorbic acid, linoleic acid, linolenic acid, arachidonic acid and octenic acid; and the like.

Examples of such alicyclic monocarboxylic acids include acetic acid, cyclopentane carboxylic acid, cyclohexane carboxylic acid and cyclooctane carboxylic acid.

The aromatic monocarboxylic acid is a monocarboxylic acid having at least one benzene ring, wherein the benzene ring may further have a substituent such as alkyl group or alkoxy group. Examples of such aromatic monocarboxylic acids include benzoic acid, xylic acid, hemellitic acid, mesitylenic acid, prehnitylic acid, γ-isodurylic acid, durylic acid, mesitoic acid, α-isodurylic acid, cuminic acid, α-toluic acid, hydroatropic acid, atropic acid, hydrocinnamic acid, salicylic acid, o-anisic acid, m-anisic acid, p-anisic acid, creosotic acid, o-homosalicylic acid, m-homosalicylic acid, p-homosalicylic acid, o-pyrocatechuic acid, β-resorcylic acid, vanillic acid, isovanillic acid, veratric acid, o-veratric acid, gallic acid, asaronic acid, mandelic acid, homoanisic acid, homovanillic acid, homoveratric acid, o-homoveratric acid, phthalonic acid, p-coumaric acid, and the like, of which benzoic acid is particularly preferred.

It is preferred that 70% or more of the hydroxyl groups of the structural sugar having a pyranose structure or a furanose structure are esterified with the monocarboxylic acid.

The sugar ester compound is preferably a compound that is produced by causing a condensation reaction of 1 to 12 units of at least one of the pyranose structure and the furanose structure of the following General Formula (A) to yield the sugar and esterifying it with the monocarboxylic acid.

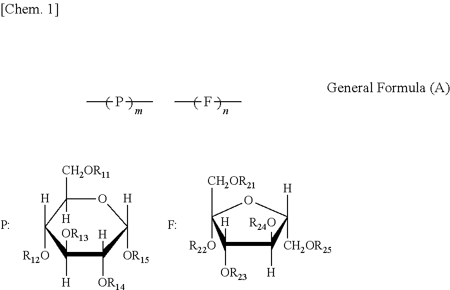

In General Formula (A), R₁₁ to R₁₅ and R₂₁ to R₂₅ each represent an acyl group of 2 to 22 carbons or a hydrogen atom. m and n is each an integer of 0 to 12, and m+n is an integer of 1 to 12.

The acyl group of 2 to 22 carbons is preferably a benzoyl group. The benzoyl group may further have a substituent, and examples of such substituents include alkyl groups, alkenyl groups, alkoxy groups and a phenyl group.

The content of the sugar ester compound is preferably within the range from 1 to 30 mass %, more preferably within the range from 5 to 30 mass % with respect to the cellulose ester in order to reduce a fluctuation in phase difference of the base (optical film), which is caused by a fluctuation in humidity, for stabilization of display quality.

Plasticizer

The base may contain a plasticizer. The plasticizer is not particularly limited, and is preferably selected from polyvalent carboxylate plasticizers, glycolate plasticizers, phthalate plasticizers, fatty acid ester plasticizers and polyvalent alcohol ester plasticizers, polyester plasticizers, acrylic plasticizers and the like. Among them, if two or more plasticizers are used, it is preferred that at least one of them is a polyalcohol ester plasticizer.

Such polyalcohol ester plasticizers, which are composed of an ester of di- or more-valent aliphatic alcohol and monocarboxylic acid, preferably have an aromatic ring or a cycloalkyl ring in the molecule. Preferred plasticizers are 2- to 20-valent aliphatic alcohol esters.

Phthalate plasticizers that can be used include diethyl phthalate, dimethoxyethyl phthalate, dimethyl phthalate, dioctyl phthalate, dibutyl phthalate, di-2-ethylhexyl phthalate, dioctyl phthalate, dicyclohexyl phthalate, dicyclohexyl terephthalate and the like.

Citrate plasticizers that can be used include acetyltrimethyl citrate, acetyltriethyl citrate, acetyltributyl citrate and the like.

Fatty acid ester plasticizers that can be used include buthyl oleate, methylacetyl ricinoleate, dibutyl cebacate, and the like.

Phosphate plasticizers that can be used include triphenyl phosphate, tricresyl phosphate, cresyldiphenyl phosphate, octyldiphenyl phosphate, diphenylbiphenyl phosphoate, trioctyl phosphate tributyl phosphoate and the like.

Polyvalent carboxylates that can be used are esters of a di- or more valent, preferably 2- to 20-valent carboxylic acid and an alcohol. The polyvalent carboxylic acid is preferably a 2- to 20-valent acid. In the case of an aromatic polyvalent carboxylic acid or an alicyclic polyvalent carboxylic acid, it is preferably a 3- to 20-valent acid.

The polyvalent carboxylic acid is represented by the following Genera Formula (a).

Rb(COOH)ₘ(OH)ₙ General Formula (a):

In General Formula (a), Rb is an (m+n)-valent organic group, m is a positive intergar of 2 or more, n is an integer of 0 or more, the COOH group is a carboxy group, and the OH group is an alcoholic hydroxy group or a phenolic hydroxy group.

Preferred examples of such polyvalent carboxylic acids include, for example, the following acids, but the present invention is not limited thereto. Tri- or more valent aromatic carboxylic acids such as trimellitic acid, trimesic acid and pyromellitic acid and the derivatives thereof, polyvalent aliphatic carboxylic acids such as succinic acid, adipic acid, azelaic acid, sebacic acid, oxalic acid, fumaric acid, maleic acid and tetrahydrophthalic acid, oxypolycarboxylic acids such as tartaric acid, tartronic acid, malic acid and citric acid are preferably used. In terms of improving the retention, it is particularly preferred to use a polyvalent oxycarboxylic acid.

Alcohols that can be used for the polyvalent carboxylates are not particularly limited, and any alcohol and phenol known in the art may be used. For example, straight or branched saturated or unsaturated aliphatic alcohols of 1 to 32 carbon(s) can be preferably used. The number of carbon(s) is more preferably 1 to 20, particularly 1 to 10. Also, alicyclic alcohols such as cyclopentanol and cyclohexanol and the derivatives thereof, aromatic alcohols such as benzyl alcohol and cinnamyl alcohol and the derivatives thereof and the like can be preferably used.

If an oxypolycarboxylic acid is used as the polyvalent carboxylic acid, the alcoholic or phenolic hydroxyl group of the oxypolycarboxylic acid may be esterified with monocarboxylic acid. Preferred examples of such monocarboxylic acids include the following acids, but the present invention is not limited thereto.

Aliphatic monocarboxylic acids that can be preferably used are straight or branched aliphatic acids of 1 to 32 carbon(s). The number of carbon(s) is more preferably 1 to 20, particularly 1 to 10.

Preferred aliphatic monocarboxylic acids include saturated fatty acids such as acetic acid, propionic acid, lactic acid, valeric acid, caproic acid, enanthic acid, caprylic acid, pelargonic acid, capric acid, 2-ethyl-hexane carboxylic acid, undecylic acid, lauric acid, tridecylic acid, nyristic acid, pentadecylic acid, palmitic acid, heptadecylic acid, stearic acid, nonadecanic acid, arachic acid, behenic acid, lignoceric acid, cerotic acid, heptacosanic acid, montanic acid, melissic acid and lacceric acid, unsaturated fatty acids such as undecylenic acid, oleic acid, sorbic acid, linoleic acid, linolenic acid and arachidonic acid, and the like.

Examples of preferred alicyclic monocarboxylic acids include cyclopentane carboxylic acid, cyclohexane carboxylic acid, cyclooctane carboxylic acid and the derivatives thereof.

Examples of preferred aromatic monocarboxylic acids include benzoic acid, benzoic acids with an alkyl group on the benzene ring such as toluic acid, aromatic monocarboxylic acids having two or more benzene rings such as biphenyl carboxylic acid, naphthalene carboxylic acid and tetralin carboxylic acid, and the derivatives thereof. In particular, acetic acid, propionic acid and benzoic acid are preferred.

The molecular weight of the polyvalent carboxylates is not particularly limited, but is preferably within the range from 300 to 1000, more preferably within the range from 350 to 750. A higher molecular weight is preferred in terms of improving the retention, while a smaller molecular weight is preferred in terms of moisture permeability and compatibility with the cellulose ester.

A pure alcohol or a mixture of two or more alcohols may be used for the polyvalent carboxylates.

The polyvalent carboxylates that can be used in the present invention have an acid value of preferably 1 mgKOH/g or less, more preferably 0.2 mgKOH/g or less. The acid value within the above range is preferred because fluctuation in retardation according to the environment is reduced.

Polyester plasticizers that can be used are not particularly limited, and may include polyester plasticizers that have an aromatic ring or a cycloalkyl ring in the molecule. Polyester plasticizers that can be used are not particularly limited, and may include, for example, the aromatic-terminated ester plasticizers of the following General Formula (b).

B-(G-A)ₙ-G-B General Formula (b):

In General Formula (b), B is a benzene monocarboxylic residue, G is an alkylene glycol residue of 2 to 12 carbons or an aryl glycol residue of 6 to 12 carbons or an oxyalkylene glycol residue of 4 to 12 carbons, A is an alkylene dicarboxylic residue of 4 to 12 carbons or an aryl dicarboxylic residue of 6 to 12 carbons, and n is an integer of 1 or more.

The aromatic-terminated ester plasticizer is composed of benzene monocarboxylic residues represented by B, alkylene glycol residues or aryl glycol residues or oxyalkylene glycol residues represented by G, and an alkylene dicarboxylic residue or an aryl dicarboxylic residue represented by A in General Formula (b), and can be produced by the same reaction as for ordinary polyester plasticizers.

Benzene monocarboxylic components of the polyester plasticizers that can be used in the present invention include, for example, benzoic acid, para-tertiallybutylbenzoic acid, ortho-toluoylic acid, meta-toluoylic acid, para-toluoylic acid, dimethylbenzoic acid, ethylbenzoic acid, normal-propylbenzoic acid, aminobenzoic acid, acetoxy benzoic acid and the like. They may be used alone or as a mixture of two or more.

Alkylene glycol components of 2 to 12 carbons of the polyester plasticizers that can be used in the present invention include ethylene glycol, 1,2-propylene glycol, 1,3-propylene glycol, 1,2-butanediol, 1,3-butanediol, 1,2-propanediol, 2-methyl-1,3-propanediol, 1,4-butanediol, 1,5-pentanediol, 2,2-dimethyl-1,3-propanediol (neopentyl glycol), 2,2-diethyl-1,3-propanediol (3,3-dimethylolpentane), 2-n-butyl-2-ethyl-1,3propanedial (3,3-dimethylolheptane), 3-methyl-1,5-pentanediol 1,6-hexanediol, 2,2,4-trimethyl-1,3-pentanediol, 2-ethyl-1,3-hexanediol, 2-methyl-1,8-octanediol, 1,9-nonanediol, 1,10-decanediol, 1,12-octadecanediol and the like. These glycols may be used alone or as a mixture of two or more. In particular, alkylene glycols of 2 to 12 carbons are particularly preferred because of the good compatibility with the cellulose ester.

Oxyalkylene glycol components of 4 to 12 carbons of the aromatic-terminated esters that can be used include, for example, diethylene glycol, triethylene glycol, tetraethylene glycol, dipropylene glycol, tripropylene glycol and the like. These glycols may be used alone or as a mixture of two or more.

Alkylene dicarboxylic components of 4 to 12 carbons of the aromatic-terminated esters that can be used include, for example, succinic acid, maleic acid, fumaric acid, glutaric acid, adipic acid, azelaic acid, sebacic acid, dodecane dicarboxylic acid and the like. They may be used alone or as a mixture of two or more. Arylene dicarboxylic acid components of 6 to 12 carbons that can be used include phthalic acid, terephthalic acid, isophthalic acid, 1,5-naphthalene dicarboxylic acid, 1,4-naphthalene dicarboxylic acid and the like.

The number average molecular weight of the polyester plasticizers that can be used in the present invention is preferably within the range from 300 to 1500, more preferably from 400 to 1000. Further, the acid value is equal to or less than 0.5 mgKOH/g, and the hydroxyl value (hydroxyl group value) is equal to or less than 25 mgKOH/g. More preferably, the acid value is equal to or less than 0.3 mgKOH/g, and the hydroxyl value (hydroxyl group value) is equal to or less than 15 mgKOH/g.

(Meth)acrylic plasticizers that can be used are preferably (meth)acrylic polymers. More preferably, such (meth)acrylic polymers include a polymer X that has a weight average molecular weight within the range from 3000 to 30000 and is produced by copolymerization of an unsaturated ethylene monomer Xa having at least no aromatic ring and no hydroxyl group in the molecule with an unsaturated ethylene monomer Xb having no aromatic ring but a hydroxy group in the molecule, and a polymer Y that has a weight average molecular weight within the range from 500 to 3000 and is produced by polymerization of an unsaturated ethylene monomer Ya having no aromatic ring.

It is more preferred that the above-described polymer X is represented by the following General Formula (X), and the polymer (Y) is represented by the following General Formula (Y).

—[CH₂—C(-Rc)(—CO₂Rd)]ₘ-[CH₂—C(—Re)(—CO₂Rf—OH)-]ₙ-[Xc]ₚ- General Formula (X)

Ry-[CH₂—C(—Rg)(—CO₂Rh—OH)-]ₖ-[Yb]_{q}- General Formula (Y)

In the formulae, Rc, Re and Rg are each H or an methyl group; Rd is an alkyl group of 1 to 12 carbon(s) or a cycloalkyl group of 3 to 12 carbons; Rf and Rh are each —CH₂—, —C₂H₄— or C₃H₆—; Ry is OH, H or an alkyl group of 3 or more carbons; Xc is a monomer unit porimerizable with Xa and Xb; Yb is a monomer unit copolymerizable with Ya; and m, n, k, p and q are each a molar compositional ratio (m≠0, n≠0, k≠0, m+n+p=100, k+q=100).

The amount of such plasticizers added is preferably within the range from 0.5 to 30 mass %, more preferably within the range from 5 to 20 mass % with respect to 100 mass % of the base resin such as cellulose ester.

Ultraviolet Absorbing Agent

The base (optical film) according to the present invention may contain an ultraviolet absorbing agent. An ultraviolet absorbing agent is intended to improve the durability by absorbing ultraviolet ray at a wavelength of 400 nm or less. In particular, the transmittance at a wavelength of 370 nm is preferably 10% or less, more preferably 5% or less, yet more preferably 2% or less.

Ultraviolet absorbing agents that can be used in the present invention are not particularly limited, and include, for example, oxybenzophenone compounds, benzotriazole compounds, salicylate compounds, cyanoacrylate compounds, triazine compounds, nickel salt complex compounds, inorganic powders and the like.

Examples thereof are 5-chloro-2-(3,5-di-sec-butyl-2-hydroxyphenyl)-2H-benzotriazole, (2-2H-benzotriazole-2-yl)-6-(straight or branched dodecyl)-4-methylphenol, 2-hydroxy-4-benzyloxybenzophenone, 2,4-benzyloxybenzophenone and the like. Further examples are TINUVINs such as TINUVIN 109, TINUVIN 171, TINUVIN 234, TINUVIN 326, TINUVIN 327, TINUVIN 328 and TINUVIN 928, all of which are commercial products of BASF Japan, Ltd., and are preferably used.

Preferred ultraviolet absorbing agents that can be used in the present invention are benzotriazole ultraviolet absorbing agents, benzophenone ultraviolet absorbing agents and triazine ultraviolet absorbing agents, of which benzotriazole ultraviolet absorbing agents and benzophenone ultraviolet absorbing agents are particularly preferred.

In addition, discotic compounds such as those having a 1,3,5-triazine ring are also preferably used as the ultraviolet absorbing agent.

It is preferred that the base (optical film) according to the present invention contains two or more ultraviolet absorbing agents.

Also, polymer ultraviolet absorbing agents can be preferably used as the ultraviolet absorbing agent. In particular, polymer ultraviolet absorbing agents described in JP Hei6-148430A are preferably used.

The ultraviolet absorbing agent may be added by dissolving the ultraviolet absorbing agent in an alcohol such as methanol, ethanol or butanol or an organic solvent such as methylene chloride, methyl acetate, acetone and dioxolane or a mixed solvent thereof, and then adding it to the dope, or by directly adding the ultraviolet absorbing agent in the dope composition.

Ultraviolet absorbing agents that are insoluble in organic solvent such as inorganic powder are added to the dope after being dispersed in an organic solvent and the cellulose ester by using a dissolver or a sand mill.

The amount of the ultraviolet absorbing agent to be used varies depending on the type of the ultraviolet absorbing agent, use conditions and the like. However, if the dry film thickness of the base (optical film) is 30 to 200 μm, the amount to be used is preferably within the range from 0.5 to 10 mass %, more preferably within the range from 0.6 to 4 mass % with respect to the total mass of the base (optical film).

Antioxidant

The base according to the present invention may contain an antioxidant. Antioxidants are also referred to as anti-degradants.

It is preferred to add an antioxidant in the base since it has a function of, for example, delaying or preventing degradation of the base caused by halogen of residual solvent or phosphoric acid of a phosphoric plasticizer in the base.

Antioxidants that are preferably used are hindered phenol compounds, for example, including 2,6-di-t-butyl-p-cresol, pentaerythrityl-tetrakis[3-(3,5-di-t-butyl-4-hydroxyphenyl)propionate], triethylene glycol-bis[3-(3-t-butyl-5-methyl-4-hydroxyphenyl)propionate], 1,6-hexanediol-bis[3-(3,5-di-t-butyl-4-hydroxyphenyl)propionate], 2,4-bis-(n-octylthio)-6-(4-hydroxy-3,5-di-t-butylanilino)-1,3,5-triazine, 2,2-thio-diethylenebis[3-(3,5-di-t-butyl-4-hydroxyphenyl)propionate], octadecyl-3-(3,5-di-t-butyl-4-hydroxyphenyl)propionate, N,N′-hexamethylenebis(3,5-di-t-butyl-4-hydroxy-hydrocinnamamide), 1,3,5-trymethyl-2,4,6-tris(3,5-di-t-butyl-4-hydroxybenzyl)benzene, tris-(3,5-di-t-butyl-4-hydroxybenzyl)-isocyanurate and the like.

In particular, 2,6-di-t-butyl-p-cresol, pentaerythrityl-tetrakis[3-(3,5-di-t-butyl-4-hydroxyphenyl)propionate] and triethylene glycol-bis[3-(3-t-butyl-5-methyl-4-hydroxyphenyl)propionate] are preferred. Further, for example, a hydrazine metal deactivator such as N,N′-bis[3-(3,5-di-t-butyl-4-hydroxyphenyl)propionyl]hydrazine or a phosphorous processing stabilizer such as tris(2,4-di-t-butylphenyl)phosphite may be used together.

The amount of such compounds added is preferably within the range from 1 mass ppm to 1.0 mass %, more preferably within the range from 10 to 1000 mass ppm with respect to 100 mass % of the base resin such as cellulose ester.

Fine Particles

It is preferred that the base according to the present invention contains fine particles.

Among fine particles that can be used in the present invention, examples of inorganic compounds include silicon dioxide, titanium dioxide, aluminum oxide, zirconium oxide, calcium carbonate, calcium carbonate, talc, clay, calcined kaolin, calcined calcium silicate, hydrated calcium silicate, aluminum silicate, magnesium silicate and calcium phosphate. Further, fine particles of organic compounds can also be preferably used. Examples of such organic compounds include polytetrafluoroethylene, cellulose acetate, polystyrene, polymethyl methacrylate, polypropyl methacrylate, polymethyl acrylate, polyethylene carbonate, acrylic styrene resins, silicone resins, polycarbonate resins, benzoguanamine resins, melamine resins, polyolefin powders, polyester resins, polyamide resins, polyimide resins, and ground and sieved product of organic polymer compounds such as polyfluoroethylene resins and starch. Further, polymer compounds synthesized by suspension polymerization, polymer compounds formed in a globular shape by spray drying, diffusion or the like, and inorganic compounds can also be used.

Fine particles that contain silicon are preferred since they reduce the turbidity. In particular, silicon dioxide is preferred.

The average primary particle size of the fine particles is preferably 5 to 400 nm, more preferably 10 to 300 nm.

The fine particles may be contained in the form of secondary aggregates having a particle size of 0.05 to 0.3 μm. If the fine particles have an average particle size of 100 to 400 nm, it is also preferred that they are contained in the form of primary particles without aggregation.

The content of the fine particles is preferably within the range from 0.01 to 1 mass %, particularly within the range from 0.05 to 0.5 mass % with respect to the total mass of the base as 100 mass %.

Fine particles of silicon dioxide are commercially available in the product names of, for example, AEROSIL R972, R972V, R974, R812, 200, 200V, 300, R202, OX50 and TT600 (Nippon Aerosil, Co., Ltd.), which can be used in the present invention.

Fine particles of zirconium oxide are commercially available in the product names of, for example, AEROSIL R976 and R811 (Nippon Aerosil, Co., Ltd.), which can be used in the present invention.

Examples of polymers include silicone resins, fluororesins, and acrylic resins. Silicone resins, in particular those having a three-dimensional network structure are preferred. Such resins are commercially available in the product names of, for example, TOSPEARL 103, 105, 108, 120, 145, 3120 and 240 (Toshiba Silicone, Co.), which can be used in the present invention.

If the base is formed in a film by casting a cellulose ester solution, the additives may be added to a dope, i.e. the cellulose ester solution before being formed in a film, in a batch manner, or the additives may be added in an in-line manner by separately preparing an additive solution. In order to reduce a burden on a filter, it is particularly preferred that the fine particles are partly or fully add in an in-line manner.

If an additive solution is added in an in-line manner, it is preferred to dissolve a small amount of cellulose ester in the solution in order to ease mixing with the dope. The amount of cellulose ester is preferably 1 to 10 parts by mass, more preferably 3 to 5 parts by mass with respect to 100 parts by mass of the solvent.

In the present invention, for example, an in-line mixer such as static mixer (TORAY Engineering Co., Ltd.) or SWJ (Toray static in-tube mixer Hi-Mixer) is preferably used for the in-line addition and mixing.

Retardation Controlling Agent

To improve the display quality of a display device such as liquid display device, an optical compensation function may be imparted to the base (optical film) by adding a retardation controlling agent in the base (optical film) or by forming an oriented film along with providing a liquid crystal layer so as to combine the retardation of a polarizing plate protection film and the liquid crystal layer. Regarding compounds that can be added to adjust the retardation, aromatic compounds having two or more aromatic rings as described in EP 911,655A2 may be used as a retardation controlling agent. Also, rod-like compounds described in JP 2006-2025A may be used. Further, two or more aromatic compounds may be used in combination. The aromatic ring of such aromatic compounds may be an aromatic hetero ring as well as an aromatic hydrocarbon ring, and an aromatic hetero ring is particularly preferred. A typical aromatic hetero ring is a nonsaturated hetero ring. Among them, 1,3,5-triazine ring compounds described in JP 2006-2026A are particularly preferred.

The amount of the retardation controlling agent added is preferably within the range from 0.5 to 20 mass %, more preferably within the range from 1 to 10 mass % with respect to 100 mass % of the base resin used.

The thickness of the base is preferably within the range from 5 to 45 μm. The base having a thickness of 5 μm or more exhibits good stretching uniformity in the stretching step. If the base has a thickness of 45 μm or less, the temperature gradient readily becomes even in the thickness direction of the base. Furthermore, if the base has a thickness of 45 μm or less, a thinner polarizing plate is achieved when the base is used as a protection film of the polarizing plate without change. Further, it is preferred that the base is a rolled film having a width of 1000 to 3000 mm.

Water Absorption Coefficient of Base

The water absorption coefficient of the base according to the present invention is preferably within the range from 0.3 to 4.3% before the laminating step. The water absorption coefficient of 0.3% or more improves the contact with the hydrophilic polymer layer at the interface, which results in good stretching uniformity of the hydrophilic polymer layer in stretching the laminate and reduced non-uniformity of the polarization degree. Further, the water absorption coefficient of 4.3% or less provides a uniform peeling surface that can prevent fractions from being left on the peeled surface when (4) the pasting step and (5) the peeling step are further carried out in addition to (1) the laminating step, (2) the stretching step and (3) the staining step.

In the base, the water absorption coefficient of polyester is approximately 0.4%, and the water absorption coefficient of cellulose triacetate, which is one of cellulose esters, is approximately 4.4%. The water absorption coefficient of the base changes when the additives are added. For example, commercially available cellulose acetate films, which contain a plasticizer and the like, have a water absorption coefficient less than 4.4%.

When the hydrophilic polymer aqueous solution applied and dried on the base is stretched, the hydrophilic polymer layer is not completely dried. Therefore, the base having such a large water absorption coefficient absorbs water from the hydrophilic polymer layer and retains it even during the stretching step.

As a result, the base having such a large water absorption coefficient has a decreased elastic modulus at the part where the hydrophilic polymer layer is laminated, which causes large difference in elastic modulus from the edge parts in transverse direction where the hydrophilic polymer layer is not laminated. If this laminate were stretched at a uniform temperature, it is presumed that the laminate would be inhomogeneously stretched because the base partly had a different elastic modulus, which would result in non-uniform polarization degree of the optical film laminate. However, by using the method for producing the optical film laminate of the present invention, non-uniformity of the polarization degree is not caused even if the base has a large water absorption coefficient.

Water absorption coefficient is determined by the following method according to Method A of JIS K7209.

A test piece is prepared by cutting an unlaminated base into a square of 50 mm in length and 50 mm in width.

After being immersed in water at 23° C., the test piece is dried in an oven maintained at 50.0±2.0° C. for 24±1 hours. Then, the test piece is placed in a desiccator to let it cooled to room temperature, and is weighed to the order of 0.1 mg. This procedure is repeated until the mass of the test piece becomes constant within ±0.1 mg (mass w₁).

Next, the test piece is put in a vessel filled with distilled water. The temperature of the distilled water is maintained at 23.0° C.±1.0° C. After being immersed for 24±1 hours, the test piece is taken out of the water, and moisture on the surface is completely removed by a clean and dry cloth or a filter paper. Within one minute of taking out of the water, the test piece is weighed again to the order of 0.1 mg (mass w₂).

The water absorption coefficient is determined by the following equation.

Water absorption coefficient C=(w₂−w₁)/w₁×100(%)

Second Optical Film

For the second optical film, the same materials as those listed in the above section “BASE” can be used. The second optical film may be a transparent protection film, however employing a variety of phase difference films make it possible to impart advanced functions such as enhanced viewing angle and color shift prevention to the polarizing plate to be produced. Since the second optical film is not affected by the stretching of the hydrophilic polymer layer, a variety of advanced functions can be imparted thereto. Furthermore, a third optical film may be pasted on the hydrophilic polymer layer on the second optical film so that the polarizing plate has the polarizing film that is sandwiched between the second optical film and the third optical film.

Dichroic Substance

By allowing a dichroic substance to adsorb on the hydrophilic polymer layer of the laminate, i.e. the hydrophilic polymer layer that is oriented by stretching the laminate in the air, the optical film laminate in which the thin polarizing film is laminated on the base can be produced.

Such dichroic substances include, for example, iodine, organic dyes and the like. Organic dyes that can be used include, for example, Red BR, Red LR, Red R, Pink LB, Rubin BL, Bourdeaux GS, Sky Blue LG, Lemon Yellow, Blue BR, Blue 2R, Navy RY, Green LG, Violet LB, Violet B, Black H, Black B, Black GSP, Yellow 3G, Yellow R, Orange LR, Orange 3R, Scarlet GL, Scarlet KGL, Congo Red, Brilliant Violet BK, Spra Blue G, Spra Blue GL, Spra Orange GL, Direct Sky Blue, Direct First Orange S, First Black and the like. These dichroic substances maybe used alone or in combination of two or more.

The staining treatment can be carried out, for example, by immersing the laminate in a solution (staining solution) containing the dichroic substance. The staining solution may be a solution in which the dichroic solution is dissolved in a solvent. The solvent is typically water, which may further contain an organic solvent that is compatible with water. The concentration of the dichroic substance is preferably within the range from 0.01 to 10 mass %, more preferably within the range from 0.02 to 7 mass %, particularly within the range from 0.025 to 5 mass %.

If iodine is used as the dichroic substance, it is preferred to further add an iodide for further improving the staining efficiency. Such iodides include, for example, potassium iodide, lithium iodide, sodium iodide, zinc iodide, aluminum iodide, lead iodide, copper iodide, barium iodide, calcium iodide, tin iodide, titanium iodide and the like. The amount of the iodide added in the staining solution is preferably within the range from 0.01 to 10 mass %, more preferably within the range from 0.1 to 5 mass %. Among them, it is preferred to add potassium iodide, and the ratio (mass ratio) of iodine to potassium iodide is preferably within the range from 1:5 to 1:100, more preferably within the range from 1:6 to 1:80, particularly within the range from 1:7 to 1:70.

The immersion time of the laminate in the staining solution is not particularly limited, but in general, is preferably within the range from 15 seconds to 5 minutes, more preferably within the range from 1 minute to 3 minutes. Further, the temperature of the staining solution is preferably within the range from 10° C. to 60° C., more preferably within the range from 20° C. to 40° C.

Instead of the immersion in the staining solution as described above, the staining treatment may be carried out, for example, by applying or spraying a solution containing the dichroic substance to the laminate.

Cross-Linking Solution

As the cross-linking agent, substances known in the art can be used. For example, such substances include boric compounds such as boric acid and borax, glyoxal, glutaraldehyde and the like. They may be used alone or in combination of two or more.

The cross-linking solution may be a solution in which the cross-linking agent is dissolved in a solvent. The solvent may be, for example, water, which may further contain an organic solvent compatible with water. The concentration of the cross-linking agent in the solution is preferably within the range from 1 to 10 mass %, more preferably within the range from 2 to 6 mass %, but is not limited thereto.

An iodide may be added to the cross-linking solution so that the polarizer can exhibit uniform performance in the plane. Such iodides include, for example, potassium iodide, lithium iodide, sodium iodide, zinc iodide, aluminum iodide, lead iodide, copper iodide, barium iodide, calcium iodide, tin iodide, titanium iodide and the like, and the content thereof is within the range from 0.05 to 15 mass %, more preferably within the range from 0.5 to 8 mass %.

Typically, the immersion time of the laminate in the cross-linking solution is preferably within the range from 15 seconds to 5 minutes, more preferably within the range from 30 seconds to 3 minutes. Further, the temperature of the cross-linking solution is preferably within the range from 20° C. to 70° C., more preferably within the range from 40° C. to 70° C.

Polarizing Plate

The hydrophilic polymer layer of the optical film laminate on which the dichroic substance adsorbs serves as a thin polarizing film. Further, the base of the optical film laminate serves as a protection film. Accordingly, the optical film laminate can be used as a polarizing plate in which the thin polarizing film and the protection film are laminated.

The polarizing plate (stretched laminate) has the base on one side of the hydrophilic polymer layer (polarizing film). The base can be used as a transparent protection film of the polarizing plate without change. Another transparent protection film may be pasted on the other side of the hydrophilic polymer layer where the base is not present.

Materials that can be used for the transparent protection film may be the same as those exemplified for the base. The thickness of the transparent optical film may be suitably selected, but is typically within the range approximately from 1 to 500 μm in consideration of processability such as handling and strength, thickness and the like. In particular, the thickness is preferably within the range from 1 to 300 μm, more preferably within the range from 5 to 200 μm. A particularly suitable transparent protection film has a thickness of 5 to 150 μm.

If transparent protection films are provided on both sides of the hydrophilic polymer layer (polarizer), both transparent protection films (including the base) may be made of the same polymer material, or they may be made of different polymer materials.

Application to Liquid Crystal Display Device

The optical film laminate can be suitably used for production of a variety of devices such as liquid crystal display device. Such liquid crystal display devices may be produced as known in the art. That is, a liquid crystal display device is typically formed by suitably assembling components including a liquid crystal cell, a polarizing plate or optical film, and if necessary, a lighting system, and further incorporating a drive circuit. By using the optical film laminate of the present invention as the polarizing plate of a liquid crystal display device, it can improve the image quality such as improved viewing angle and eliminated color shift. The optical film laminate of the present invention can exert these advantageous effects in various types of liquid crystal cells, and may be combined with any type of liquid crystal cells such as TN type, STN type, π type, VA type and IPS type.

Application to Organic Electroluminescence Display Device (Also Referred to as Organic EL Display Device)

Organic EL display devices have a luminescent body (organic electroluminescent body) that is formed by sequentially laminating a transparent electrode, an organic light emitting layer and a metal electrode on a transparent base. In order to prevent the metal electrode from reflecting external light to cause a decrease of the image contrast in a non-light emitting state, a circular polarizing plate is used in organic EL display devices. By using a π/4 phase difference film as the second optical film, the second optical film laminate serves as a circular polarizing plate. By using this film laminate in organic EL display devices, it can exert an advantageous effect of improving the contrast.

### EXAMPLES

Hereinafter, the present invention will be specifically described with examples, however the present invention is not intended to be limited thereto. The term “part(s)” and the symbol “%” used in the examples refer respectively to “part(s) by mass” and “mass %” unless otherwise noted.

### Example 1

### Preparation of Optical Film Laminate 1

An amorphous polyester base of 140 μm in thickness and 1490 mm in width was prepared from a continuous web of isophthalic acid-copolymerized polyethylene terephthalate that has a degree of polymerization of 1500 and a content of copolymerized isophthalic acid of 6 mol % (hereinafter referred to as “amorphous PET”). The water absorption coefficient of the amorphous PET was 0.4%, which was measured according to the method described in the above section “WATER ABSORPTION COEFFICIENT OF BASE”. The glass transition temperature of the amorphous PET was 75° C.

Laminating Step

Using polyvinyl alcohol (hereinafter referred to as “PVA”) as a hydrophilic polymer, a laminate of the amorphous PET continuous web base and a PVA layer was prepared as follows. The glass transition temperature of the PVA is 80° C.

A PVA powder having a degree of polymerization of 1000 and a degree of saponification of 99% was dissolved in water to prepare a PVA aqueous solution at a 4.5 mass % concentration. Then, the PVA aqueous solution is applied on the base to a width of 1450 mm, and is dried at a temperature within the range from 50° C. to 70° C. to prepare a continuous web laminate of a 10 μm-thick PVA layer and 140 μm-thick base. In the continuous web laminate, the parts where the PVA layer is not laminated on the base were present on both edges in transverse direction in a width of 20 mm.

Stretching Step

The laminate including the 10 μm-thick PVA layer was passed through a stretching machine in an oven 20 at 95° C. (in which 95° C. air flows) so that it was stretched in the machine direction in the air at a stretching ratio of 2. A stretched laminate including a 5 μm-thick PVA layer was thus prepared. The temperature of the surface of the base, which was measured by a radiation thermometer during the stretching, was 95° C. over the whole surface.

Staining Step

The stretched laminate was immersed in a staining solution at 30° C. containing iodine and potassium iodide to allow the iodine to adsorb on the PVA layer of the stretched laminate, in which the immersion time was controlled so that the produced PVA layer finally had a transmittance of light at a wavelength of 550 nm within the range from 40% to 44%. The stained laminate was thus prepared. The staining solution contains water as solvent, iodine at a 0.30 mass % concentration and potassium iodide at a 2.1 mass % concentration.

Cross-Linking Step

In the cross-linking step, the stained laminate was further stretched in the machine direction integrally with the amorphous PET base. The thickness of the PVA layer became 3 μm, and the thickness of the base became 42 μm. The laminate was washed and dried. An optical film laminate 1 having a PVA layer thickness of 3 μm and a base thickness of 42 μm was thus prepared. To be more specific, the cross-linking step involved processing the stained laminate with processing equipment that is configured to perform a treatment with a boric acid aqueous solution at 65° C. containing 4 mass % of boric acid and 5 mass % of potassium iodide, in which the stained laminate passed through a stretching machine installed in the processing equipment to be stretched in the machine direction for a time period within the range from 30 to 90 seconds so that the stretch ratio between before the stretching step and after the cross-linking step became 3.3.

Preparation of Optical Film Laminates 2 to 5

Each of optical film laminates 2 to 5 was prepared in the same manner as the preparation of the optical film laminate 1 except that, in the stretching, heaters 25 and 26 blow air in the oven 20 to both edge parts of the laminate where the PVA layer is not laminated in addition to the laminate passing through the stretching machine in the oven so that the temperature of the edge parts of the base where the PVA layer was not laminated became the value listed in Table 1 while the temperature of the oven was controlled according to need so that the temperature of the center part of the base became 95° C.

The temperature of the base surface during the stretching was measured by a radiation thermometer. The water absorption coefficient of the bases was 0.4%, the thickness of the PVA layers of the optical film laminates 2 to 5 were 3 μm, and the thickness of the bases was 42 μm.

Preparation of Optical Film Laminate 6

An optical film laminate 6 including a 3 μm-thick PVA layer and a 42 μm-thick base was prepared in the same manner as the preparation of the optical film laminate 2 except that a continuous web of 140 μm in thickness and 1490 mm in width made of cellulose triacetate film 1 (a film of cellulose triacetate having a weight average molecular weight of 240000) was used as the base, and the temperatures of the oven 20 and the heaters 25 and 26 were controlled so as to control the temperature of the edge parts of the base and the temperature of the center part of the base to the values as listed in Table 1.

The water absorption coefficient of the cellulose triacetate film 1 was 4.4%, which was measured according to the method described in the above section “WATER ABSORPTION COEFFICIENT OF BASE”. Further, the glass transition temperature of the cellulose triacetate film 1 was 160° C., and the crystallization temperature thereof was 195° C.

Preparation of Optical Film Laminates 7 to 13

Each of optical film laminates 7 to 13 was prepared in the same manner as the preparation of the optical film laminate 1 except that, in addition to applying the PVA aqueous solution so that the PVA layer (hydrophilic polymer layer) of the optical film laminate has a thickness as listed in Table 1 and passing the laminates through the stretching machine in the oven 20, the heaters 25 and 26 blow air in the oven to both edge parts of the laminate where the PVA layer is not laminated in the stretching, wherein the temperatures of the oven and the heaters were controlled so that the temperature of the edge parts of the base where the PVA layer was not laminated and the temperature of the center part of the base became the values as listed in Table 1. The temperature of the bases surface was measured by a radiation thermometer. The thickness of the PVA layers of the optical film laminates 7 to 13 was 3 μm and the thickness of the bases was 42 μm.

Synthesis of Aromatic-Terminated Ester Plasticizer 1

In a reaction vessel, 410 parts of phthalic acid, 610 parts of benzoic acid, 737 parts of dipropylene glycol and 0.40 parts of tetraisopropyl titanate as a catalyzer were charged at once, and the mixture was heated at 130° C. to 250° C. while stirring under nitrogen flow and refluxing the excessive monovalent alcohol by a reflux condense, so as to continuously remove produced water until the acid value became equal to or less than 2. Then, at 200° C. to 230° C., the pressure was reduced to 1.33×10⁴ Pa to finally 4×10² Pa to remove the distillate, and the residue was thereafter filtrated. An aromatic-terminated ester plasticizer 1 having the following properties was thus obtained.

Viscosity: 43400 (mPa·s, 25° C.)

Acid value: 0.2

Preparation of Optical Film Laminate 14

An optical film laminate 14 including a 3 μm-thick PVA layer and a 42 μm-thick base was prepared in the same manner as the preparation of the optical film laminate 6 except that the cellulose triacetate film 1 of the base was replaced with a cellulose triacetate film 2 that was prepared by adding 5.0 mass % of the aromatic-terminated ester plasticizer 1 to cellulose triacetate having a weight average molecular weight of 240000.

Specification of the cellulose triacetate film 2: Thickness: 140 μm, Width: 1490 mm, Glass transition temperature: 150° C., Crystallization temperature: 190° C., Water absorption coefficient (measured by the method described in the above section “Water Absorption Coefficient of Base”): 4.3%.

Preparation of Optical Film Laminate 15

An optical film laminate 15 including a 3 μm-thick PVA layer and a 42 μm-thick base was prepared in the same manner as the preparation of the optical film laminate 2 except that a polycarbonate film having the following specification was used as the base, and the temperature of the center part of the base and the temperature of the edge parts of the base were controlled as listed in Table 1.

Specification of the polycarbonate film: Thickness: 140 μm, Width: 1490 mm, Weight average molecular weight: 100000, Glass transition temperature: 150° C., Water absorption coefficient (measured by the method described in the above section “WATER ABSORPTION COEFFICIENT OF BASE”): 0.2%.

Preparation of Optical Film Laminate 16

An optical film laminate 16 including a 3 μm-thick PVA layer and a 42 μm-thick base was prepared in the same manner as the preparation of the optical film laminate 2 except that a film of DELPET 80N (Asahi Kasei Chemicals Corporation; acrylic resin, glass transition temperature of 107° C.) having the following specification was used as the base, and the temperature of the center part of the base and the temperature of the edge parts of the base were controlled to the values as listed in Table 1.

Specification of the film: Thickness: 140 μm, Width: 1490 mm, Water absorption coefficient (measured by the method described in the above section “WATER ABSORPTION COEFFICIENT OF BASE”): 0.3%.

Preparation of Optical Film Laminates 17 to 20

Each of optical Film Laminates 17 to 20 was prepared in the same manner as the preparation of the optical film laminate 5 except that the thickness of the base of the optical film laminate was changed to 4 μm, 5 μm, 45 μm or 46 μm as listed in Table 1 by adjusting the thickness of the base before the laminating step.

Evaluation of Polarization Degree Non-Uniformity

In the following conditions, the polarization degree of each optical film laminate at the center part in the transverse direction was measured, which was referred to as polarization degree A. Further, the polarization degree of each optical film laminate at 25 mm inward from an edge of the PVA layer in the transverse direction was measured, which was referred to as polarization degree B. The ratio A/B was determined. The closer the ratio is to 1, the better the polarization degree uniformity is. Similarly, the further the ratio is from 1, the worse the polarization degree uniformity is.

Polarization degree meter: UV-2200 (Shimadzu Corporation)

Measurement Environment: Temperature: 23° C., Relative humidity: 55%

(Evaluation Criteria of Polarization Degree Non-Uniformity)

∘: 0.999≦A/B≦1.001

Δ: 0.998≦A/B<0.999 or 1.001<A/B≦1.002

x: A/B<0.998 or 1.002<A/B

In the table, cellulose triacetate is referred to as cellulose ester.

TABLE 1

| | | | | OPTICAL FILM LAMINATE | |
|---|---|---|---|---|---|
| | | | | | HYDROPHILIC |
| | | | | | POLYMER |
| OPTICAL | | ABSORPTION | | BASE | LAYER |
| FILM | BASE | COEFFICIENT | | THICKNESS | THICKNESS |
| LAMINATE | RESIN | OF BASE (%) | | (μm) | (μm) |
| 1 | AMORPHOUS | 0.4 | | 42 | 3 |
| | POLYESTER | | | | |
| 2 | AMORPHOUS | 0.4 | | 42 | 3 |
| | POLYESTER | | | | |
| 3 | AMORPHOUS | 0.4 | | 42 | 3 |
| | POLYESTER | | | | |
| 4 | AMORPHOUS | 0.4 | | 42 | 3 |
| | POLYESTER | | | | |
| 5 | AMORPHOUS | 0.4 | | 42 | 3 |
| | POLYESTER | | | | |
| 6 | CELLULOSE | 4.4 | | 42 | 3 |
| | ESTER | | | | |
| 7 | AMORPHOUS | 0.4 | | 42 | 1 |
| | POLYESTER | | | | |
| 8 | AMORPHOUS | 0.4 | | 42 | 2 |
| | POLYESTER | | | | |
| 9 | AMORPHOUS | 0.4 | | 42 | 6 |
| | POLYESTER | | | | |
| 10 | AMORPHOUS | 0.4 | | 42 | 10 |
| | POLYESTER | | | | |
| 11 | AMORPHOUS | 0.4 | | 42 | 15 |
| | POLYESTER | | | | |
| 12 | AMORPHOUS | 0.4 | | 42 | 3 |
| | POLYESTER | | | | |
| 13 | AMORPHOUS | 0.4 | | 42 | 3 |
| | POLYESTER | | | | |
| | AIR STRETCHING | | | | |
| | | | TEMPERATURE | EVALUATION OF | |
| | | | DIFFERENCE | POLARIZATION | |
| | TEMPERATURE | TEMPERATURE | BETWEEN | DEGREE | |
| OPTICAL | OF CENTER | OF EDGES | EDGES AND | NON-UNIFORMITY | |
| FILM | OF BASE | OF BASE | CENTER OF | OF OPTICAL | |
| LAMINATE | (° C.) | (° C.) | BASE | FILM LAMINATE | REMARKS |
| 1 | 95 | 95 | 0 | x | FOR |
| | | | | | COMPARISON |
| 2 | 95 | 136 | 41 | x | FOR |
| | | | | | COMPARISON |
| 3 | 95 | 96 | 1 | ∘ | PRESENT |
| | | | | | INVENTION |
| 4 | 95 | 135 | 40 | ∘ | PRESENT |
| | | | | | INVENTION |
| 5 | 95 | 115 | 20 | ∘ | PRESENT |
| | | | | | INVENTION |
| 6 | 170 | 185 | 15 | ∘ | PRESENT |
| | | | | | INVENTION |
| 7 | 95 | 115 | 20 | Δ | PRESENT |
| | | | | | INVENTION |
| 8 | 95 | 115 | 20 | ∘ | PRESENT |
| | | | | | INVENTION |
| 9 | 95 | 115 | 20 | ∘ | PRESENT |
| | | | | | INVENTION |
| 10 | 95 | 115 | 20 | ∘ | PRESENT |
| | | | | | INVENTION |
| 11 | 95 | 115 | 20 | ∘ | PRESENT |
| | | | | | INVENTION |
| 12 | 115 | 125 | 10 | ∘ | PRESENT |
| | | | | | INVENTION |
| 13 | 80 | 90 | 10 | ∘ | PRESENT |
| | | | | | INVENTION |

Temperature Difference between Edges and Center of Base (° C.)=Temperature of Edges of Base (° C.)−Temperature of Edges of Base (° C.)

As can be seen from Table 1, the polarization degree non-uniformity is improved when the temperature of the edge parts of the base in the transverse direction is controlled to be 1° C. to 40° C. higher than the temperature of the center part of the base in the transverse direction during the air stretching.

### Example 2

### Preparation of Optical Film Laminates 101 to 120

Each of optical film laminates 101 to 120 (PVA/TAC laminate webs) corresponding to the optical film laminates 1 to 20 was produced by pasting a 24 μm-thick triacetylcellulose (TAC) film on the surface of the PVA layer of each of the respective optical film laminate webs 1 to 20 while applying an adhesive, and peeling off the amorphous PET base, cellulose ester base polycarbonate base or acrylic resin base.

Evaluation of Polarization Degree Non-Uniformity and Appearance

Polarization degree non-uniformity and appearance were evaluated for the optical film laminates 101 to 120 as with Example 1. The results are shown in Table 2.

### Example 3

### Preparation of Polarizing Plates 101 to 120

Each of polarizing plate webs 101 to 120, which was a laminate of TAC/PVA layer/TAC, was prepared by pasting a 24 μm-thick triacetylcellulose (TAC) film on the surface of the PVA layer of each of the respective optical film laminate webs 101 to 120 while applying an adhesive.

Preparation of Liquid Crystal Display Devices 101 to 120

The polarizing plate webs 101 to 120 prepared as described above were slit at 10 mm inward from the edges of the PVA layer to remove the edge parts to obtain silt polarizing plate webs. Each slit polarizing plate web was cut into a rectangle having the same size as the polarizing plate of a 42-inch liquid crystal television (VIERA TH-L42G3, Panasonic Corporation) such that one edge of the polarizing plate becomes one side of the rectangle. The 42-inch polarizing plates 101 to 120 were thus obtained. The rectangle was cut in such a direction that the absorption axis conforms to that of the polarizing plates that were originally pasted on a VIERA TH-42G3.

Using the 42-inch polarizing plates 101 to 120, liquid crystal display devices 101 to 120 were manufactured according to the following method.

The liquid crystal display devices 101 to 120 were each manufactured by peeling off the polarizing plates of a 42-inch liquid crystal television (Panasonic Corporation, VIERA TH-L42G3) that were originally pasted on both sides, and pasting the respective 42-inch polarizing plates 101 to 120 prepared as described above on both glass sides of the liquid crystal cell in such a direction that the absorbing axis conforms to that of the originally pasted polarizing plates.

The liquid display devices 101 to 120 manufactured as described above were subjected to an evaluation of contrast non-uniformity.

Evaluation of Contrast Non-Uniformity

The contrast non-uniformity (bright and dark) in a black display mode or influence on image display two hours after a back light turns on was evaluated for the above-described liquid crystal display devices. When the evaluation result of contrast non-uniformity is Δ or higher, a device has no problem. The determination was made according to the following criteria. The results are shown in Table 2.

∘: Contrast non-uniformity is not observed at all.

Δ: A weak contrast non-uniformity is observed, but it does not bother in image display.

x: A strong contrast non-uniformity is observed, and it also bothers in image display.

The results are shown in Table 2.

TABLE 2

| | | EVALU- | | |
|---|---|---|---|---|
| | | ATION OF | | |
| | | OPTICAL | EVALU- | |
| | | FILM | ATION OF | |
| | | LAMINATE | LIQUID | |
| | | POLAR- | CRYSTAL | |
| OPTICAL | | IZATION | DEVICE | |
| FILM | LIQUID | DEGREE | CONTRAST | |
| LAMIN- | DISPLAY | NON- | NON- | |
| ATE | DEVICE | UNIFORMITY | UNIFORMITY | REMARKS |
| 101 | 101 | x | x | FOR COM- |
| | | | | PARISON |
| 102 | 102 | x | x | FOR COM- |
| | | | | PARISON |
| 103 | 103 | ∘ | ∘ | PRESENT |
| | | | | INVENTION |
| 104 | 104 | ∘ | ∘ | PRESENT |
| | | | | INVENTION |
| 105 | 105 | ∘ | ∘ | PRESENT |
| | | | | INVENTION |
| 106 | 106 | ∘ | ∘ | PRESENT |
| | | | | INVENTION |
| 107 | 107 | Δ | Δ | PRESENT |
| | | | | INVENTION |
| 108 | 108 | ∘ | ∘ | PRESENT |
| | | | | INVENTION |
| 109 | 109 | ∘ | ∘ | PRESENT |
| | | | | INVENTION |
| 110 | 110 | ∘ | ∘ | PRESENT |
| | | | | INVENTION |
| 111 | 111 | ∘ | ∘ | PRESENT |
| | | | | INVENTION |
| 112 | 112 | ∘ | ∘ | PRESENT |
| | | | | INVENTION |
| 113 | 113 | ∘ | ∘ | PRESENT |
| | | | | INVENTION |

As can be seen from Table 2, the polarization degree non-uniformity is improved also in the optical film laminates in which the hydrophilic polymer layer and the second optical film are laminated when the temperature of the edge parts of the base in the transverse direction is controlled to be 1° C. to 40° C. higher than the temperature of the center part of the base in the transverse direction during the air stretching. Further, the liquid crystal display devices using the optical film laminates have improved contrast non-uniformity.

### INDUSTRIAL APPLICABILITY

The optical film laminate that is produced by the production method of the present invention is a thin polarizing film that has uniform polarization degree in the width direction, and can therefore be suitably used for thin polarizing plates and liquid display devices.

### DESCRIPTION OF REFERENCE NUMERALS

1 laminating step
2 stretching step
3 staining step
4 washing and drying step
6 roll
7 roll
11 application machine
12 dryer
20 oven
25 heater
26 heater
31 staining solution
32 staining bath
41 washing machine
42 dryer

1. A method for producing an optical film laminate, comprising:
(1) a laminating step of laminating a hydrophilic polymer layer on a thermoplastic resin base to form a laminate;
(2) a stretching step of stretching the laminate in the air to form a stretched laminate comprising the oriented hydrophilic polymer layer; and
(3) a staining step of allowing a dichroic substance to adsorb on the hydrophilic polymer layer,
wherein, in the stretching step in the air, a temperature of an edge part of the base in a transverse direction where the hydrophilic polymer layer is not laminated is 1° C. to 40° C. higher than a temperature of a center part of the base in the transverse direction.

2. The method for producing the optical film laminate according to claim 1,
wherein the hydrophilic polymer layer of the optical film laminate has a thickness within a range from 2 to 10 μm,
wherein the base of the optical film laminate has a thickness within a range from 5 to 45 μm, and
wherein the base before the laminating step has a water absorption coefficient determined by the following Expression (1) according to JIS K 7209 (Method A) within a range from 0.3% to 4.3%,
Water absorption coefficient=(w₂−w₁)/w₁×100(%), Expression (1):
where w₁ is a dry mass (mg) of a test piece before being immersed in water, and w₂ is a mass (mg) of the test piece after being immersed in water at 23.0±1.0° C. for 24±1 hours.

3. The method for producing the optical film laminate according to claim 1, wherein a hydrophilic polymer of the hydrophilic polymer layer is a polyvinyl alcohol resin.

4. The method for producing the optical film laminate according to claim 1, wherein the hydrophilic polymer layer is a thin polarizing film that is adjusted such that a polarization degree A at a center of the thin polarizing film in the transverse direction and a polarization degree B at 25 mm inward from an edge of the thin polarization film in the transverse direction satisfy the following Expression (2).
0.999≦A/B≦1.001 Expression (2):

5. The method for producing the optical film laminate according to claim 1, further comprising, in addition to the steps (1) to (3), the steps of:
(4) a pasting step of pasting a second optical film on a surface of the hydrophilic polymer layer via an adhesive; and
(5) a peeling step of peeling off the base.

6. A thin polarizing film that is a hydrophilic polymer layer having a thickness of 2 to 10 μm, wherein a polarization degree A at a center of the polarizing film in a transverse direction and a polarization degree B at 25 mm inward from an edge of the polarization film in the transverse direction satisfy the following Expression (2),
0.999≦A/B≦1.001. Expression (2):

7. A polarizing plate comprising an optical film laminate that is produced by the method for producing the optical film laminate according to claim 1.

8. A liquid display device comprising an optical film laminate that is produced by the method for producing the optical film laminate according to claim 1.
